(19) United States
(12) Patent Application Publication
(10) Pub. No.: US 2022/0274141 A1
(43) Pub. Date: Sep. 1, 2022

(54) DEVICE FOR SORTING ITEMS OF CLOTHING

(71) Applicant: IMMOBILIARE METALPROGETTI S.R.L., Perugia (IT)

(72) Inventor: Enrico Maria SANTICCHI, Perugia (IT)

(21) Appl. No.: 17/635,026

(22) PCT Filed: Aug. 13, 2020
(86) PCT No.: PCT/IT2020/050204

§ 371 Date: Feb. 14, 2022

(30) Foreign Application Priority Data
Aug. 13, 2019 (IT) 102019000014730

(51) Int. Cl. B07C 5/36; B65G 47/71

(52) U.S. Cl. CPC B07C 5/36; B65G 47/71; B65G 2201/0229

(57) ABSTRACT

Device for sorting items of clothing comprising a main rail which has an end section in correspondence with which there are a sorting zone, a movement member suitable to support items of clothing and slidably coupled with the main rail, and a motor unit configured to drive the sliding of the movement member along the main rail.

### FIELD OF THE INVENTION

The present invention concerns a device for sorting items of clothing.

The invention can be used, preferably but not necessarily, for moving items of clothing, by way of a non-restrictive example, in plants for treating items of clothing, in particular in the context of industrial cleaning plants, or plants for processing and packaging items of clothing, or of other plants which require the items to be disposed in groups ordered according to different parameters which depend on their characteristics.

In particular, the present invention allows to separate in a desired manner, that is, in accordance with the different parameters as above, the items of clothing in transit on a main movement line, or on one or more secondary movement lines.

### BACKGROUND OF THE INVENTION

It is known that movement lines for transporting, for example, items of clothing, generally comprise a shaped section bar, or a rail, which serves as a support and guide for a sliding movement member which supports the items of clothing hanging on suitable supports.

The activities that provide to manage numerous items of clothing, as occurs for example in industrial cleaning plants, use these movement lines, whether automated or not, by means of which the items of clothing are moved to the various treatment stations and/or operational zones of the plant.

These plants treat hundreds of items of clothing at the same time, which may have different characteristics in terms of material, finishes, end use, or may belong to countless customers, or again may be in different stages of the treatment cycle. Therefore, management is often laborious and a source of errors such as damage, loss or incorrect distribution during delivery to the customer.

For example, in a plant of this type, a movement line can be used to feed items of clothing to any machine able to perform a specific operation on one or more items of clothing, for example, a washing machine, a machine for starching the items of clothing, an ironing machine, a bagging machine or a labeling machine.

The operations that are carried out on the items of clothing depend on their characteristics, or on the specific requests of the customer, therefore the items of clothing that have to undergo a specific operation must be suitably extracted from the movement line and then reintroduced into it in a mostly random order.

Typically, the items of clothing, at the end of the operations envisaged, are moved by a movement line to an unloading or delivery zone, where they can end their travel.

The unloading or delivery zone can be, for example, a zone for storing the items of clothing, in correspondence with which logistics operations are carried out, or delivery to the customer.

Sorting plants of the type known in the state of the art and comprising automated lines for moving the items of clothing between the different stations of the plant are described, for example, in U.S. patent applications no. U.S. Pat. No. 5,377,814 A and U.S. Pat. No. 2,846,049 A.

One of the disadvantages most frequently complained of by operators in the sector is that the items of clothing that arrive in the unloading zone have an order that makes it long and laborious to divide them up. Often, in fact, an operator is obliged to sort the items of clothing manually, slowing down these operations and introducing possible errors.

Another disadvantage is that the unloading zone can therefore become saturated with items of clothing, slowing down or blocking the operations upstream as well as those downstream.

There is therefore a need to perfect a movement line for items of clothing that can overcome at least one of the disadvantages of the state of the art.

One purpose of the present invention is to provide a device for sorting items of clothing that allows easy ordering and classification thereof.

Another purpose of the present invention is to provide a device for sorting items of clothing that improves the organization of the work and spaces in the unloading or delivery zone thereof.

Another purpose of the present invention is to provide a device for sorting items of clothing that prevents slowdowns in the plant, consequently increasing its productivity.

Another purpose of the present invention is to provide a device for sorting items of clothing that allows to automate the operations of sorting the items of clothing by reducing or eliminating the need for dedicated operators.

Another purpose of the present invention is to provide a device for sorting items of clothing that is simple and economical.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a device for sorting items of clothing that can be applied to an industrial plant comprises: a main rail which has an end section in correspondence with which there are a sorting zone, a movement member suitable to support items of clothing which is slidably coupled with the main rail, and a motor unit to drive the movement member along the main rail. The device has, in correspondence with the sorting zone, a plurality of secondary rails which develop distally with respect to the end section of the main rail, a guide, interposed between the main rail and the plurality of secondary rails, and a drive device to drive the guide, suitable to selectively put the main rail in communication with one of the secondary rails.

In particular, the drive device allows to move the guide from a first position in which it puts the main rail in communication with a first selected one of the secondary rails, to a plurality of second positions in which it puts the main rail in communication with each of the other secondary rails different from the first selected secondary rail.

In accordance with the purposes of the invention, the sorting device allows an operator to check the destination of the items of clothing moving on a movement line or rail, toward a movement line chosen from a plurality of movement lines or secondary rails.

According to some embodiments, the control of the sorting device, and therefore the destination of the items of clothing, can be assigned to a command and control unit, for example a computer, in which an operator can enter the parameters or criteria to carry out the sorting.

The items of clothing can be equipped with special devices on which information is stored that allows the command and control unit to recognize them.

The command and control unit can, on the basis of the parameters or criteria entered in it, drive the drive device that moves the guide in order to allocate the items of clothing on the correct rail.

In accordance with the purposes of the invention, the sorting device can provide at least one sensor suitable to read the signals as above and send the information contained therein to the command and control unit.

### ILLUSTRATION OF THE DRAWINGS

These and other aspects, characteristics and advantages of the present invention will become apparent from the following description of some embodiments, given as a non-restrictive example with reference to the attached drawings wherein:

FIG. 1 is a perspective view of a device for sorting items of clothing in accordance with some embodiments described here;

FIG. 2 is an enlarged detail of FIG. 1;

FIG. 3 is another perspective view of a device for sorting items of clothing in accordance with some embodiments described here;

FIG. 4 is an enlarged perspective view of a device for sorting items of clothing in accordance with some embodiments described here

FIG. 5 is a top view of an industrial cleaning plant in which the device for sorting items of clothing of FIG. 1 is applied.

To facilitate comprehension, the same reference numbers have been used, where possible, to identify identical common elements in the drawings. It is understood that elements and characteristics of one embodiment can conveniently be incorporated into other embodiments without further clarifications.

### DESCRIPTION OF EMBODIMENTS

We will now refer in detail to the various embodiments of the invention, of which one or more examples are shown in the attached drawings. Each example is supplied by way of illustration of the invention and shall not be understood as a limitation thereof For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

The present invention concerns a device for sorting items of clothing, indicated as a whole with reference number 10 in the attached drawings.

Here and hereafter in the description, the term item of clothing refers to any type of clothing and/or wearable garment whatsoever, such as for example shirts, T-shirts, pants or trousers, dresses, coats, etc.

Although the present invention concerns moving and sorting items of clothing, in general the device 10 can be used for sorting and ordering any article whatsoever, moved on one or more movement lines or carousels.

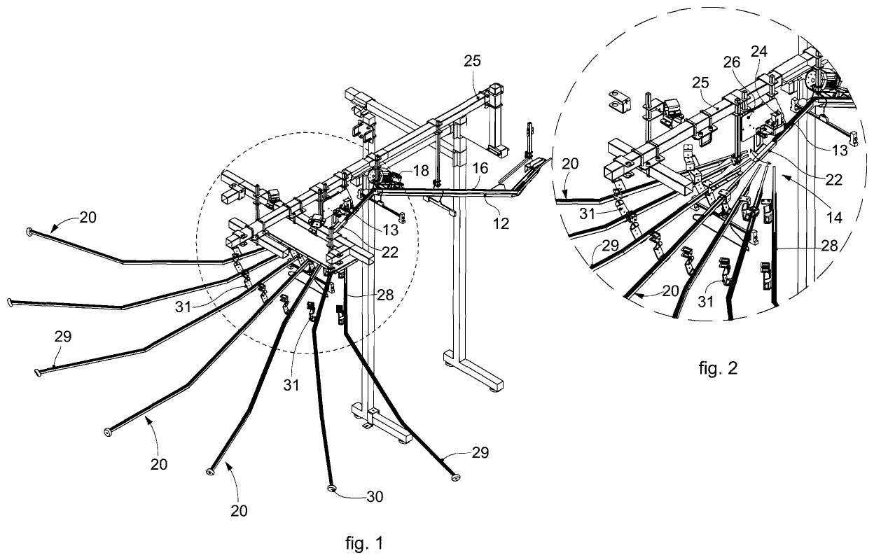

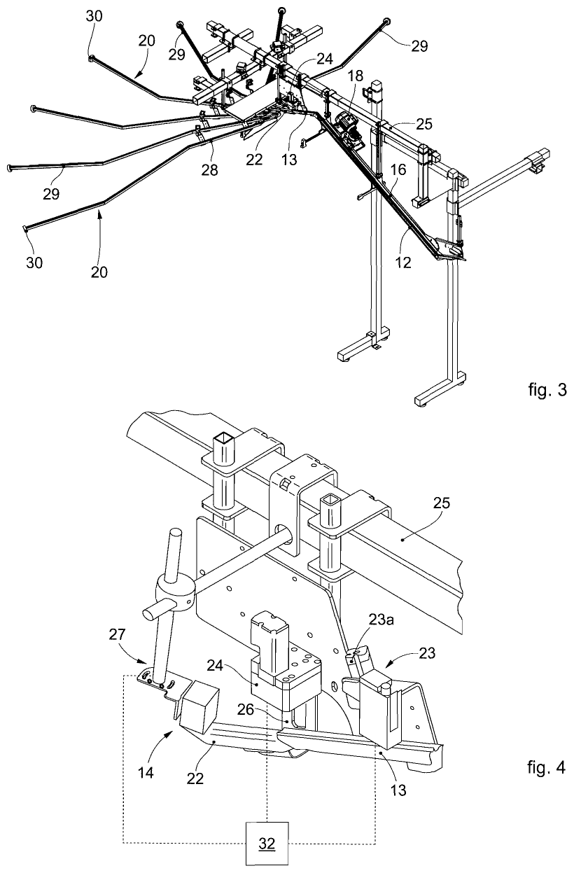

In accordance with some embodiments, shown in FIGS. 1 and 2, a device 10 for sorting items of clothing comprises a main rail 12 which has an end section 13 in correspondence with which there is a sorting zone 14, a movement member 16 suitable to support items of clothing which is slidably coupled with the main rail 12, and a motor unit 18 configured to drive the movement member 16 along the main rail 12.

In accordance with one aspect of the present invention, the device 10 comprises, in correspondence with the sorting zone 14, a plurality of secondary rails 20 which develop distally with respect to the end section 13 of the main rail 12 and are configured to receive the items of clothing sorted according to appropriate criteria. The device 10 comprises a guide 22 interposed between the main rail 12 and the plurality of secondary rails 20, and a drive device 24 to drive the guide 22 from a first position in which it puts the main rail 12 in communication with a first selected one of the secondary rails 20, to a plurality of second positions in which it puts the main rail 12 in communication with each of the other secondary rails 20, different from the first selected secondary rail 20. For this purpose, the guide 22 is configured to connect one rail 20 with the end section 13, defining a path suitable for the sliding of one or more items of clothing from the section 13 to the desired rail 20.

In accordance with some embodiments, the guide 22 can be connected to a frame 25 through at least one support element 26.

In accordance with some embodiments, the support element 26 can be integral with the guide 22.

According to other embodiments, the guide 22 can be connected in other positions, for example, to the main rail 12.

In further embodiments, the guide 22 can be connected to at least one rail 20.

The guide 22 has, with respect to its longitudinal axis, two opposite ends, the guide 22 being substantially disposed in such a way that one of the opposite ends as above is oriented toward the end section 13 of the main rail 12 and the other of the opposite ends as above is oriented toward the plurality of secondary rails 20 or, on each occasion, toward one of them.

In accordance with possible embodiments, the guide 22 can be positioned at a different height with respect to the end section 13 of the main rail 12 and therefore can have a positive or negative inclination, that is, it can have a downward or upward inclination with respect thereto.

In accordance with further possible embodiments, the guide 22 can be positioned substantially on the same plane as the end section 13 of the main rail 12.

In accordance with some embodiments, the guide 22 can be mobile and have an amplitude of movement such that it is able to connect at least a part of the plurality of rails 20 with the end section 13. For this purpose, the guide 22 can contact, or not contact, the end section 13 and/or the rail 20. In any case, it is necessary to provide that the possible distance between the opposite ends of the guide 22 respectively from the end section 13 and from the rail 20 is compatible with, and allows the sliding of, the movement member 16 without causing interruptions, failures or blockages in the movement of the items of clothing

According to some embodiments, the secondary rails 20 have, with respect to the guide 22, a proximal section 28 configured to receive the items of clothing from the guide 22 and a distal section 29 configured for their arrangement.

Some embodiments can provide that the final end of the distal section 29 has clamping elements 30 in order to prevent items of clothing from coming out of the rail 20.

According to other embodiments, the final end of the distal section 29 can, for example, be connected to and/or resting on walls or other similar structures in order to allow the rails 20 to better support the weight of the items of clothing weighing on them.

Advantageously, this solution allows to use rails 20 of such a length that they cannot be supported by the attachment elements 31 alone and therefore, possibly, to reach positions distant from the sorting zone 14.

In accordance with some embodiments, the distal section 29 can be sized in length and diameter according to the number of items of clothing it is to be able to receive.

In other embodiments, the rails 20 can be suitably connected directly to a machine of a plant and/or to other movement lines.

According to some embodiments, the rails 20 can have, at least partly, along their longitudinal development, one or more inclinations in order to facilitate the sliding of the items of clothing, for example due to gravity, toward the distal section 29. For this purpose, each rail 20 it can have the respective distal section 29 at a lower level than the respective proximal section 28.

According to some embodiments, at least the proximal section 28 can have an inclination that facilitates the sliding of the items of clothing due to gravity toward the distal section 29. In this way, it is possible to prevent unwanted stasis of the items of clothing in the sorting zone 14.

In further embodiments, the rails 20 can have a distal section 29 substantially parallel to the ground in order to prevent crushing of the items of clothing just moved due to gravity.

In accordance with some embodiments, the rails 20 are positioned so that the distance between the end of their proximal section 28 and the end of the end section 13 of the main rail 12 substantially corresponds to the length of the guide 22.

According to some embodiments, the rails 20 can be disposed so that they are divergent from each other with respect to the sorting zone 14.

In accordance with some embodiments, the degree of divergence can be greater in correspondence with the distal sections 29, that is, the distal sections 29 of the rails 20 are much more distanced with respect to each other than the corresponding proximal sections 28. In this way, advantageously, the distal sections 29 of the rails 20 can be sufficiently separated to accommodate the items of clothing without there being interferences with those disposed on the adjacent rails 20, and the proximal sections 28 can be sufficiently close to limit the reciprocal distance from the end section 13 of the main rail 12.

According to some embodiments, the proximal sections 28 of the plurality of rails 20 are coplanar to each other. In this way, it is possible to reduce the possible corrective movements of the guide 22 to reach the desired final inclination necessary to define the slidable communication as above.

According to some embodiments, the device 10 can comprise attachment elements 31, disposed along the development of each rail 20, and configured to connect the rails 20 to the support frame 25 in a stable manner

According to other embodiments, the rails 20 can be attached to the frame 25 so as to be mobile with respect thereto. This, advantageously, allows to distance each rail 20 from the others in a desired manner, both in order to make the passage of the items of clothing easier and also in order to better occupy spaces.

According to some embodiments, the sizes and length of the rails 20 are suitable for the load they have to support and for the surrounding development space.

Further embodiments provide that the sorting device 10 can have at least one sensor 27 suitable to recognize a special code applied to the item of clothing in transit on the main rail 12 (FIG. 4).

According to some embodiments, the sensor 27 can be provided in correspondence with any portion of the main rail 12 whatsoever.

In accordance with embodiments shown in FIG. 4, the sensor 27 can be disposed in correspondence with the guide 22.

The sensor 27 can be supported by the main rail 12, by the frame 25, as shown in FIG. 4, or also by other dedicated supports.

According to some embodiments, the sensor 27 can be a scanning reader to read linear or bi-dimensional codes, for example bar codes, QR codes or to interact with RFID radiofrequency identification codes.

In accordance with embodiments shown in FIG. 4, the sorting device can provide a command and control unit 32 which can be associated at least with the drive device 24 and with the sensor 27.

In further embodiments, the command and control unit 32 can also be associated with the motor member 18.

In accordance with some embodiments, an operator enters in the command and control unit 32 the parameters or criteria according to which the items of clothing are directed to a specific destination rail 20.

Some embodiments provide that the command and control unit 32 activates the drive device 24 on the basis of the information received from the sensor 27.

The sensor 27 can advantageously prevent errors which could occur upstream thereof, such as, for example, re-hanging up an item of clothing that has fallen along the main rail 12 in an incorrect position.

In other embodiments, the sorting device 10 can be provided with a clamping device 23 (FIG. 4) configured to prevent an item of clothing from continuing toward any one secondary rail 20 whatsoever.

In accordance with some embodiments, the clamping device 23 is positioned upstream of the secondary rails 20. In the example shown in FIG. 4, the clamping device 23 is associated with the end section 13 of the main rail 12, but it can obviously also be associated, in a completely similar manner, also in another point of the sorting zone 14.

In other embodiments not shown here, clamping devices 23 can be provided for each secondary rail 20.

According to some embodiments, the clamping device 23 can be supported by the frame 25.

According to some embodiments not shown here, the clamping device 23 can be connected to the command and control unit 32 in such a way as to be driven, by a suitable respective drive device 23a, on the basis of the information read by the sensor 27.

Some embodiments can provide that the clamping device 23 is driven by the same device 24 that moves the guide 22.

According to some embodiments, in the event of anomalies or malfunctions the command and control unit 32 can deactivate the motor member 18 in order to prevent errors in the sorting of the items of clothing.

In other embodiments not shown here, there can be provided a member of the hydraulic and/or electric type connected to the drive device 24 and which can be driven by an operator by means of a command, for example a lever or a button.

In accordance with some embodiments, the sorting device 10 can be provided with devices for remote communication, for example Wi-Fi or other similar, configured to communicate remotely by means of a portable electronic device such as a smartphone, a laptop, a tablet etc. in order to drive the drive device 24.

In further embodiments not shown here, the guide 22 is provided with means of the mechanical and non-automatic type, in order to be moved manually by an operator.

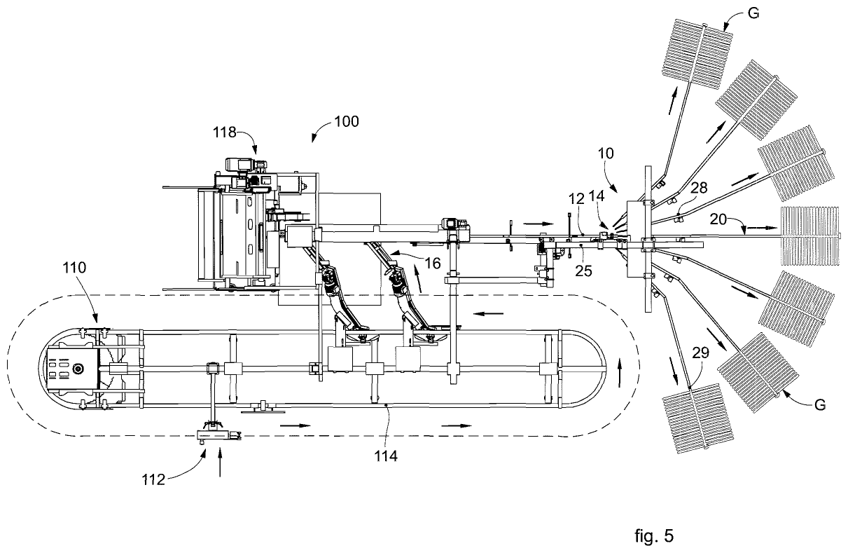

In accordance with some embodiments, the present invention can be favorably applied to a plant 100 for treating items of clothing G, shown in FIG. 5, and configured in particular to receive and package items of clothing G.

The plant 100 can comprise a conveyor 110 for recomposing the batches of items of clothing introduced in correspondence with an entrance 112.

According to some embodiments, the items of clothing introduced can already have undergone treatments, for example, washing and/or drying and/or ironing treatments.

According to some embodiments, the conveyor 110 comprises a conveyor belt 114 to move the items of clothing G in a direction D.

Embodiments of the present invention can provide that the conveyor 110 has a conveyor belt 114 closed in a loop.

The cleaning plant 100 can comprise one or more extraction means 116 configured to remove the items of clothing from the conveyor 110.

In accordance with some embodiments, the extraction means 116 can be connected to any apparatus whatsoever for treating items of clothing G, such as for example a bagging machine 118.

In other embodiments, the extraction means 116 can be connected to other movement lines or transport conveyors.

In accordance with some embodiments, the bagging machine 118 can be connected to the sorting device 10 according to the present invention.

According to some embodiments, the bagging machine 118 is connected to the sorting device 10 by the movement line 12.

According to embodiments shown in FIG. 5, the sorting device 10 is provided with seven rails 20 on which a plurality of items of clothing G are ordered schematically and by way of example.

In accordance with some embodiments, a method is provided to sort items of clothing comprising moving items of clothing along a main rail 12 up to a sorting zone 14; recognizing, in a zone located upstream of the sorting zone 14, the item of clothing by reading a respective identification code with a sensor 27; driving the drive device 24 in order to move the guide 22 so as to connect the main rail 12 with the desired rail 20.

It is clear that modifications and/or additions of parts may be made to the device for sorting items of clothing and to the method as described heretofore, without departing from the field and scope of the present invention.

It is also clear that, although the present invention has been described with reference to some specific examples, a person of skill in the art shall certainly be able to achieve many other equivalent forms of device for sorting items of clothing and/or method, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. Device for sorting items of clothing, comprising a main rail which has an end section in correspondence with which there are a sorting zone, a movement member suitable to support items of clothing slidably coupled with the main rail, and a motor unit configured to drive the movement member along the main rail, wherein said sorting device comprises, in correspondence with the sorting zone, a plurality of secondary rails which develop distally with respect to the end section of the main rail, a guide, interposed between said main rail and said plurality of secondary rails, and a drive device to drive the guide from a first position in which it puts said main rail in communication with a first selected one of said secondary rails, to a plurality of second positions in which it puts said main rail in communication with each of the other secondary rails different from said first selected secondary rail.

2. Device for sorting items of clothing as in claim 1, wherein the guide has, with respect to its longitudinal axis, two opposite ends, said guide being substantially disposed so that one of said opposite ends is oriented toward the end section of the main rail and the other of said opposite ends is oriented toward the plurality of secondary rails.

3. Device for sorting items of clothing as in claim 1, wherein the guide is mobile in order to connect at least one rail at a time of the plurality of rails with the end section.

4. Device for sorting items of clothing as in claim 1, wherein the guide can be positioned at a different height with respect to the end section of the main rail and has a positive or negative inclination, that is, it can have respectively a downward or upward inclination, with respect to said end section.

5. Device for sorting items of clothing as in claim 1, wherein the secondary rails have, with respect to the guide, a proximal section configured to receive the items of clothing from the guide and a distal section configured for their arrangement.

6. Device for sorting items of clothing as in claim 5, wherein the rails are divergent from each other with respect to the sorting zone so that said distal sections of the rails are much more distanced from each other than the corresponding proximal sections of said rails.

7. Device for sorting items of clothing as in claim 5, wherein the rails have the distal section at a lower height than the proximal section to facilitate the sliding of the items of clothing from said proximal section to said distal section.

8. Device for sorting items of clothing as in claim 1, wherein it comprises a command and control unit to enter criteria for sorting the items of clothing and a sensor, connected to said command and control unit, suitable to recognize a suitable code applied to the item of clothing in transit on the main rail.

9. Device for sorting items of clothing as in claim 1, wherein it comprises a clamping device positioned in correspondence with the sorting zone, upstream of the secondary rails, or associated with each of said secondary rails, and configured to prevent an item of clothing from continuing toward said secondary rails.

10. Device for sorting items of clothing as in claim 8, wherein the command and control unit is configured to automatically drive the drive device and/or said clamping device, in particular on the basis of the information received from the sensor.

11. Industrial plant for treating items of clothing comprising a conveyor which receives from an entrance items of clothing to be moved, supported by a conveyor belt, and at least one extractor to remove said items of clothing from said conveyor belt and move them toward a packaging device, wherein it comprises a device for sorting items of clothing as in claim from 1.

12. Method to sort items of clothing with a sorting device as in claim 1 comprising moving items of clothing along a main rail up to a sorting zone; recognizing, in a zone located upstream of said sorting zone, the item of clothing by reading a respective identification code with a sensor; driving the drive device in order to move the guide so as to connect said main rail with a desired secondary rail comprised in a plurality of secondary rails which develop distally with respect to an end section of said main rail.
